(19) United States
(12) Patent Application Publication
(10) Pub. No.: US 2016/0185164 A1
(43) Pub. Date: Jun. 30, 2016

(54) AUTOMATED DRIVE TIRE PNEUMATIC AIR SYSTEM FOR WHEELED PAVERS

(71) Applicant: CATERPILLAR PAVING PRODUCTS INC., Brooklyn Park, MN (US)

(72) Inventor: Chad M. Thiesse, Brooklyn Park, MN (US)

(73) Assignee: CATERPILLAR PAVING PRODUCTS INC., Brooklyn Park, MN (US)

(21) Appl. No.: 15/060,603

(22) Filed: Mar. 4, 2016

(51) Int. Cl. B60C 23/00; E01C 19/00

(52) U.S. Cl. CPC B60C 23/004; E01C 19/00

(57) ABSTRACT

A paving machine including a pneumatic tire, a compressor and vent unit coupled to the pneumatic tire, and a pressure regulation controller system is disclosed. The compressor and vent unit are configured to adjust tire pressure of the pneumatic tire according to a tire adjustment pressure. The compressor and vent unit is also coupled to the pressure regulation controller system. The pressure regulation controller system measures a current tire inflation pressure of the pneumatic tire. Further, the pressure regulation controller system determines the target tire inflation pressure according to a predetermine mode. The pressure regulation controller system is also configured to determine the tire adjustment pressure according to the current tire inflation pressure and the target tire inflation pressure. Moreover, the pressure regulation controller system is configured to transmit the tire adjustment pressure to the compressor and vent unit for adjusting the tire pressure of the pneumatic tire.

### TECHNICAL FIELD

The present disclosure generally relates to a paving machine and more particularly, to an apparatus for automatically controlling tire pressure of the paving machine.

### BACKGROUND

Paving machines, also variously called a paver, a paver finisher, an asphalt finisher, are frequently employed for paving concrete, asphalt and other surfaces associated with roadbed and other land areas. A paving machine generally includes a tractor and a screed. The tractor has a hopper for receiving asphalt material from a truck and a conveyor system for transferring the asphalt material rearwardly from the hopper for discharge onto a roadbed. Screw augers may be used to spread the asphalt transversely across the roadbed in front of a screed. The screed includes a plate that smoothens and compacts discharged asphalt material and leave a roadbed of uniform depth and smoothness. One such type of screed includes a floating screed.

The floating screed is articulated on a chassis of the paving machine by a pair of tow arms. During paving process, the floating screed is allowed to float over the discharged asphalt material. As the tractor moves forward, the floating screed rides and flattens the discharged asphalt material to pave a smooth asphalt mat. Since the screed is floating on the asphalt mat while paving, its mass is not carried by the paving machine. In other words, the load of the screed is not transferred to the drive wheels of the tractor while paving.

Further, for successful operation of the paving machine, the ground contact area should be managed in accordance with paver operational conditions. For example, while paving it is ideal to lower the tire pressure to maximize tire ground contact area which generates increased traction. Typically, an operator manages ground contact area by deflating the tires to achieve more around contact.

Further, when the paving job is complete, the floating screed must be raised which loads the mass of the screed onto the tractor drive wheels. Hence, the drive wheel tire pressure must be increased high enough to support the increased load and machine speed in this condition.

Accordingly, it would be beneficial to provide a system for controlling the drive wheel tire pressure on the tractor that does not require operator intervention, and is thus fully automated and capable of achieving appropriate tire pressures to maximize tractive effort while paving and support any given load condition.

### SUMMARY OF THE DISCLOSURE

The present disclosure provides a paving machine. The paving machine includes a pneumatic tire. Further, the paving machine includes a compressor and vent unit coupled to the pneumatic tire. The compressor and vent unit are configured to adjust tire pressure of the pneumatic tire according to a tire adjustment pressure. Further, the paving machine includes a pressure regulating controller system. The pressure regulation controller system is coupled to the compressor and vent unit. The pressure regulation controller system is configured to measure a current tire pressure of the pneumatic tire. Further, the pressure regulation controller system determines the target tire pressure for the paving machine according to a predetermined mode. The pressure regulation controller system is also configured to determine the tire adjustment pressure according to the difference between the current tire pressure and the target tire pressure. Moreover, the pressure regulation controller system is configured to transmit the tire adjustment pressure to the compressor and vent unit for adjusting the tire pressure of the pneumatic tire. Further, the pressure regulation controller system inflate or deflate the pneumatic tire to adjust the tire pressure of the pneumatic tire to achieve the target tire inflation pressure.

### BRIEF DESCRIPTION OF THE DRAWINGS

FIG. 1 is a schematic drawing of a work machine, in accordance with the concepts of the present disclosure;

FIG. 2 is a block diagram of an exemplary system that may be configured to perform certain functions consistent with embodiments of the present disclosure; and

FIG. 3 is a flowchart depicting an exemplary method of adjusting tire pressure of the paving machine, in accordance with the concepts of the present disclosure.

### DETAILED DESCRIPTION

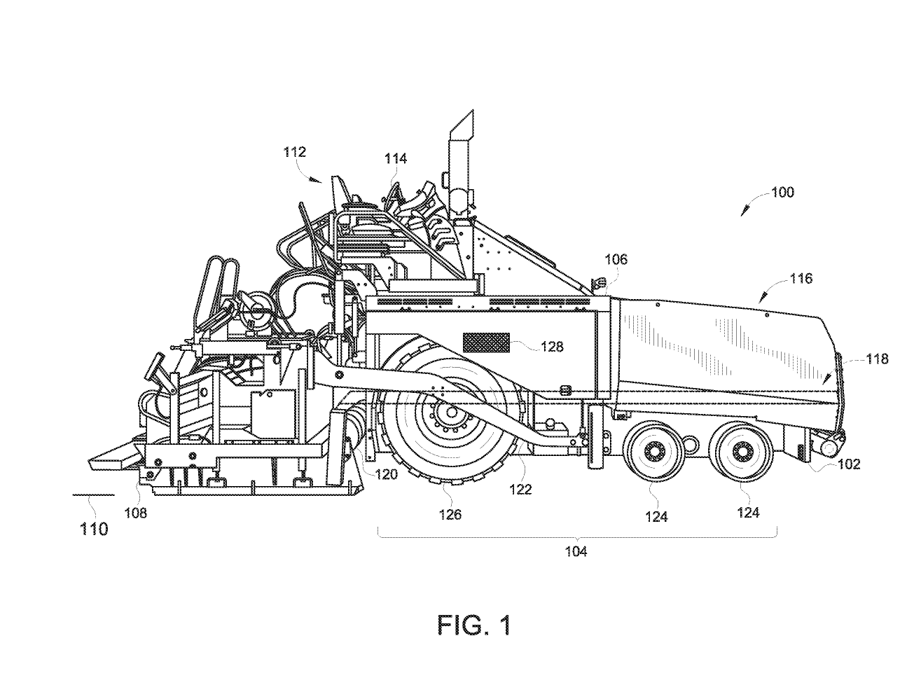

Referring to FIG. 1, an exemplary paving machine 100 is shown. The paving machine 100 includes a frame 102 with a set of ground-engaging elements 104, such as pneumatic tires, wheels, coupled with the frame 102. The ground-engaging elements 104 are driven by an engine 106 in a conventional manner. The engine 106 further drives an associated generator (not shown) that is used to power various systems on the paving machine 100. A screed 108 is attached at a rear end of the paving machine 100 to spread and compact paving material into a layer or mat of desired thickness, size and uniformity on a paving surface 110. The paving machine 100 also includes an operator station 112 having a seat and an operating station 114, which may include various controls for directing operations of the paving machine 100.

The paving machine 100 further includes a hopper 116 configured to store a paving material, and a conveyor system including one or more conveyors 118 configured to move the paving material from the hopper 116 to the screed 108. The conveyors 118 are arranged at a bottom of the hopper 116 and, if more than one is provided, may be positioned side-by-side and run parallel to one another back to the rear of the paving machine 100. The speed of the one or more conveyors 118 is adjustable in order to control the rate at which paving material may be delivered to the screed 108.

One or more augers 120 are arranged near the forward end of the screed 108 to receive the paving material supplied by the conveyor 118 and spread the material evenly beneath the screed 108. Although only one auger 120 is shown in FIG. 1, the paving machine 100 may have a single auger or any number of augers.

As shown in FIG. 1, the screed 108 is pivotally connected behind the paving machine 100 by a pair of tow arms 122 (only one of which is visible in FIG. 1). The tow arms 122 extend between the frame 102 of the paving machine 100 and the screed 108. The tow arms 122 are pivotally connected to the frame 102 such that, the relative position and orientation of the screed 108 relative to the frame 102 and the paving surface 110, may be adjusted by pivoting the tow arms 122. For example, to control the thickness of the paving material deposited via the paving machine 100, such as a paving depth.

The ground-engaging elements 104 of paving machine 100 may have a set of tires containing solid rubber bonded front set of tires 124 and pneumatically inflated rear set of tires 126. Both front and rear sets of tires 124, 126 being rotatably mounted on a frame 102 of the paving machine 100. The set of tires of each of the respective front and rear sets of tires 124, 126, may be structurally and operatively equivalent, or in some instances, the size and structure of the front and rear sets of tires 124, 126 may deviate from each other.

The rear sets of tires 124, 126 carry the weight of the paving machine 100 including the weight of the screed 108. However, during paving operation, the screed 108 is positioned to rest on the paving surface 110. In this position, the screed 108 is said to be in ‘float mode’. The tow arms 122 are adjusted so as to allow the screed 108 to reach a state of equilibrium with respect to weight on the tow arms 122. In other words, the screed 108 floats vertically over the paving material placed in front of it during the paving operation. Since, the screed 108 is floating on the asphalt mat while paving, its mass is not carried by the rear set of tires 126 of the paving machine 100. In other words, the load of the screed 108 is transferred off the front and rear sets of tires 124, 126 of the paving machine 100.

Furthermore, when the screed 108 is not in float mode or when paving job is complete, the screed 108 is raised up by the tow arms 122 and the screed 108 is said to be in ‘screed up’ mode. The screed up mode loads the rear sets of tires 126.

Hence the screed 108 is said to be in a predetermined mode during paving and non-paving operation. During the paving operation, the predetermined mode can be float mode, whereas during the non-paving operation, the predetermined mode can be travel mode or screed up mode.

It will be appreciated by those skilled in the art that actual performance of a paving machine 100 will vary as a function of tire inflation pressure. Thus, low tire inflation pressures will generally improve traction and durability of a paving machine 100 during the paving mode for pulling the screed 108, for example, while higher tire inflation pressures will provide more efficient results during travel mode or screed up mode. As such, it may be advantageous to automatically vary the tire inflation pressure as a function of real-time operating mode of the paving machine 100.

In addition, according to an embodiment herein, the paving machine 100 may include a pressure regulating controller system 128 (or simply a controller system 128) which operates as an onboard tire pressure management system. The controller system 128 is adapted to measure current tire inflation pressure, and to automatically achieve and maintain any given target tire inflation pressure for the predetermined mode of operation of the paving machine 100.

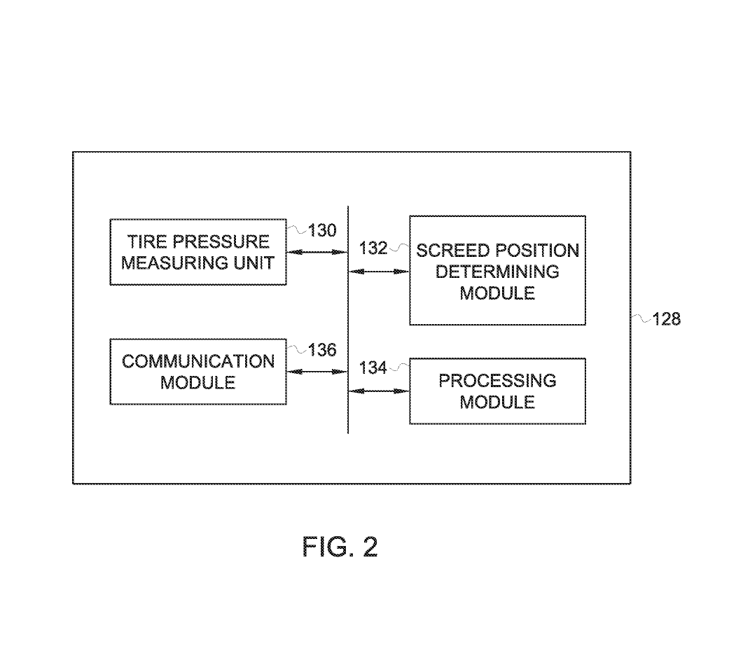

Referring now to FIGS. 1 and 2, according to an embodiment herein, the paving machine 100 may include the pressure regulating controller system 128 which operates as an onboard tire pressure management system. The controller system 128 is adapted to measure current tire inflation pressure, and to automatically achieve and maintain any given target tire inflation pressure. In order to achieve this result, the controller system 128 controls an air compressor and at least one vent unit to manage tire pressure of the rear sets of tires 126. The compressor unit may include an air compressor unit and the vent unit may include a valve unit configured to vent the tire pressure to atmosphere.

Additionally, each of the tires of the rear set of tires 126 may be pneumatically interconnected, such that all pressures within each tire may be equivalent or may vary in accordance with any particular desired operation.

In the disclosed embodiment of FIG. 2, the controller system 128 may be programmed with relevant parameters of the paving machine 100, including, e.g., paving material, overall machine weight, number of tires, ambient temperature, and tire ground contact area. Equipped with said parameters, the controller system 128 may be programmed to determine screed mode, automatically compare and calculate an appropriate tire inflation pressure, display same for the operator while recording same for future reference, and to adjust the tire inflation pressure in real time for achieving maximum efficiency.

By way of example, and in further reference to FIG. 2, the controller system 128 includes a tire pressure measuring unit 130, a screed position determining module 132, and a processing module 134. The controller system 128 may be programmed as shown to determine a target tire inflation pressure, utilizing the identified parameters including current tire inflation pressure, screed mode and target tire inflation pressure based on the screed mode.

The tire pressure measuring unit 130 can be a tire pressure measuring sensor configured to determine the tire inflation pressure. For example, the tire pressure measuring unit 130 can be a direct or indirect Tire Pressure Monitoring System (TPMS). The direct TPMS may include pressure sensors mounted on tire. The sensors may physically measure the tire pressure in each tire. The pressure sensors can be mounted either internal or external to the tire. For example, the pressure sensors can be mounted in the valve stem of the tire. In one example, the pressure sensor may also measure and alert temperatures of the tire. In another example, the pressure sensor can be a strain gauge sensor mounted on the tire walls configured to determine load and or pressure on the tire walls. The tire inflation pressure can be measured based on information from strain gauge.

The indirect TPMS may include independent pressure sensors within each tire. The pressure sensors are capable of determining the speed of rotation of the tire and transmit the speed information to an electronic control module (ECM). The ECM can process the information on the speed of each tire and determine inflation pressure of each tire.

The controller system 128 further includes the screed position determining module 132. The screed position determining module 132 is configured to determine the current state of the screed 108. For example, the screed position determining module 132 can determine if the screed 108 is in float mode or screed up mode. In one embodiment, the screed position determining module 132 may include a position sensor in screed actuation mechanism (not shown) of the screed 108 to determine the position of the screed 108. In another embodiment, the screed 108 may include a weight sensor or cameras to determine the current state of the screed 108.

The controller system 128 further includes a processing module 134. The processing module 134 is configured to compare the current tire inflation pressure to a target tire inflation pressure based on the position of the screed 108. For example, the processing module 134 can include a look-up table to compare the current tire inflation pressure with a target tire inflation pressure when the screed is in float mode. Once such comparison is made, the processing module 134 determines a tire adjustment pressure. In one embodiment, the tire adjustment pressure can be difference between the current tire inflation pressure and the target tire inflation pressure. In another embodiment, the tire adjustment pressure can be a polynomial function of the current tire inflation pressure and the target tire inflation pressure.

Moreover, the controller system 128 includes a communication module 136. The communication module 136 can be programmed to communicate a command signal corresponding to the tire adjustment pressure. For example, in a float mode of the screed 108, if the processing module 134 determines that the tire adjustment pressure pertains to decreasing the current tire inflation pressure. The communication module 136 commands a signal to the vent valve for venting the tire to attain the target tire inflation pressure.

In an alternate example, in a screed up mode of the screed 108, if the processing module 134 determines that the tire adjustment pressure pertains to increasing the current tire inflation pressure. The communication module 136 commands a signal to the air compressor for inflating the tire to attain the target tire inflation pressure. Hence, the controller system 128 may use the processing module 134 to provide a signal to inflate or deflate the pneumatic tire, rear set of tire 126, to adjust the tire pressure of the pneumatic tire and to achieve the target tire inflation pressure.

The controller system 128 may also be programmed with additional enhancements. In particular, a machine cab data display unit may provide a real-time readout of current tire inflation pressure and/or the target tire inflation pressure. The controller system 128 may support capability for receiving a pressure value for only one tire, but then may convert same to the actual number of tires.

The controller system 128 may be part of a comprehensive system wherein the plurality of tires can be collectively managed under a unified pressure subsystem under which the paver tires can be incrementally inflated and/or deflated collectively to achieve a common determined target tire inflation pressure.

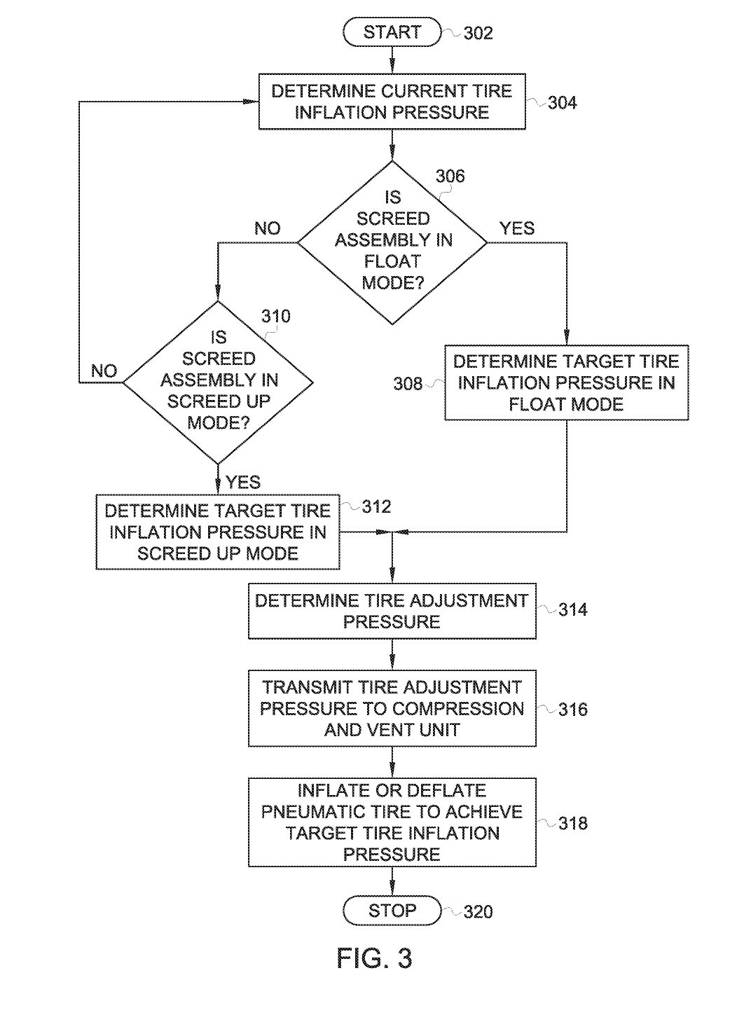

In reference to FIG. 3, a paving machine 100 may incorporate a method 300 for adjusting tire pressure in the rear sets of tires 126.

The method 300 begins at step 302. At step 304, the paving machine 100 incorporates the controller system 128 and tire pressure measuring unit 130 determines the current tire inflation pressure for the rear sets of the tires 126.

Thereafter, the method proceeds to step 306. At step 306, the screed position determining module 132 is configured to determine the state of the screed 108. The screed position determining module 132 determines if the screed 108 is in the predetermined float mode. The method proceeds to step 308, when the screed position determining module 132 determines the screed 108 is in float mode, else the method proceeds to step 310.

At step 308, the processing module 134 determines the target tire inflation pressure. The current tire inflation pressure is compared to a lookup table based on the position of the screed 108. At this step, the processing module 134 scans a look-up table to determine the target tire inflation pressure in float mode.

At step 310 the screed position determining module 132 determines if the screed 108 is in travel mode or screed up mode, when the screed 108 is not in float mode.

Thereafter, the method 300 proceeds to step 312, when the screed position determining module 132 determines the screed 108 is in the predetermined screed up mode, else the method proceeds back to step 304.

At step 312, the processing module 134 determined the target tire inflation pressure. The processing module 134 compares the current tire inflation pressure in a look up table for screed up mode to determine target tire inflation pressure. The current tire inflation pressure of the rear set of tires 126 is compared to the lookup table based on the position of the predetermined mode of screed up mode of the screed 108. Thereafter the method proceeds to step 314.

At step 314, a tire adjustment pressure is determined based on the comparison of the current tire inflation pressure with a lookup table based on the position of the screed 108. For example, at this step 314, the processing module 134 scans a look-up table for float mode and compare the current tire inflation pressure with a target tire inflation pressure to determine the tire adjustment pressure. In another example, the processing module 134 scans a look-up table for screed up mode and compare the current tire inflation pressure with a target tire inflation pressure to determine the tire adjustment pressure.

Once such comparison is made and the processing module 134 determines a tire adjustment pressure the method proceeds to next step 316. In one embodiment, the tire adjustment pressure can be difference between the current tire inflation pressure and the target tire inflation pressure. In another embodiment, the tire adjustment pressure can be a polynomial function of the current tire inflation pressure and target tire inflation pressure.

At step 316 the communication module 136 communicates a command signal corresponding to the tire adjustment pressure. The command signal can pertain to inflating or deflating the inflation pressure of the one or more tires of the rear sets of the tires 126 to achieve the target tire inflation pressure. For example, in a float mode of the screed 108, the communication module 136 may communicate a signal to the vent valve for venting the tire to attain the target tire inflation pressure. In an alternate example, in a screed up mode of the screed 108, the communication module 136 communicates a signal to the air compressor for inflating the tire to attain the target tire inflation pressure.

Thereafter at step 318, the pressure regulation controller system may command to inflate or deflate the rear set of the tires 126 to adjust the tire pressure of the pneumatic tire to achieve the target tire inflation pressure.

Thereafter, the method terminates at step 320.

### INDUSTRIAL APPLICABILITY

In operation, the paving machine 100 may be used to pave a surface, such as an asphalt roadbed. The controller system 128 may be useful to an operator to maintain a desired or target tire inflation pressure by selectively pressurizing and deflating the rear sets of tires 126. The controller system 128 may be adapted to maintain such target tire inflation pressure by utilizing current tire inflation pressure, and the position of the screed 108. For example, when paving operation is complete and the paving machine 100 needs to travel a short distance, the controller system 128 may command to inflate the rear sets of tires 126. However, when the paving machine 100 is paving and need more traction to push a truck or pave uphill, the controller system 128 may command to deflate the rear sets of tires 126 to get more traction. In the disclosed embodiment, an operator may have the benefit of managing a tire inflation pressure directly from the vehicle cab.

What is claimed is:

1. A paving machine comprising:
a pneumatic tire;
a compressor and vent unit coupled to the pneumatic tire, the compressor and vent unit configured to adjust tire pressure of the pneumatic tire according to a tire adjustment pressure;
a pressure regulating controller system coupled to the compressor and vent unit configured to:
measure a current tire inflation pressure of the pneumatic tire;
determine a target tire inflation pressure for the paving machine according to a predetermined mode;
determine the tire adjustment pressure according to the difference between the current tire inflation pressure and the target tire inflation pressure;
transmit the tire adjustment pressure to the compressor and vent unit; and
inflate or deflate the pneumatic tire to adjust the tire pressure of the pneumatic tire to achieve the target tire inflation pressure.
